(19) United States
(12) Patent Application Publication
(10) Pub. No.: US 2024/0129675 A1
(43) Pub. Date: Apr. 18, 2024

(54) STEREO TYPE DIGITAL HEARING DEVICE AND METHOD FOR CONNECTING WITH AN EXTERNAL DEVICE WITH BUILT-IN MICROPHONE AND OPERATING METHOD THEREFOR

(71) Applicant: Olive Union, Inc., Seoul (KR)

(72) Inventors: Myunggeun Song, Seoul (KR); Yoonsoo Kim, Seoul (KR); Donghyun Lee, Seoul (KR)

(73) Assignee: Olive Union, Inc., Seoul (KR)

(21) Appl. No.: 18/489,621

(22) Filed: Oct. 18, 2023

(30) Foreign Application Priority Data
Oct. 18, 2022 (KR) 10-2022-0133863

(51) Int. Cl. H04R 25/00; H04R 25/02

(52) U.S. Cl. CPC H04R 25/552; H04R 25/02; H04R 25/405; H04R 25/505; H04R 2225/025

(57) ABSTRACT

A stereo type digital hearing device connected with an external device with built-in microphone and an operation method thereof are proposed. An operation method of a stereo type digital hearing device connected with an external device with built-in microphone according to an embodiment may include connecting a digital hearing device worn by a user and an external device carried by the user or located around the user to each other through wireless communication; receiving external sound through a microphone built in the external device; transmitting the sound received from the external device to the digital hearing device; and amplifying the sound transmitted from the digital hearing device and delivering it to the user through a speaker.

This application claims the priority benefit of Korean Patent Application No. 10-2022-0133863, filed on Oct. 18, 2022, in the Korean Intellectual Property Office, the disclosure of which is incorporated herein by reference.

### BACKGROUND

### 1. Field of the Invention

The following embodiments relate to a stereo type digital hearing device connected with an external device with built-in microphone and an operation method thereof, and more particularly, relate to a stereo type digital hearing device that allows feeling sense of direction and space similar to sound heard in ears through a microphone configured in an external device.

### 2. Description of Related Art

Recently, by leapfrogging development of medical engineering technology, patients who had not previously received great help from wearing hearing aids may improve good hearing by selecting and wearing appropriate hearing aids. Hearing aids are high-tech devices that are always attached to body among medical devices, and they must be constantly managed according to changes in hearing and receive after sales service for damaged parts caused by humidity and foreign substances in ears. The existing hearing aids were in a form of trumpet-shaped sound collector, but now they are usually used in a form of electric hearing aids helping to amplify sound. Also, hearing aids have a bone-conducting type attached to mastoid part, but mostly have an air conduction type, and they receive sound waves through a microphone, convert it to electric vibration, magnify it, and turn it back into sound waves by an earphone to make it heard in ears.

“Sense of direction” of a microphone of a hearing aid can help users using hearing aids hear better. Generally, hearing aids use two sparse microphones having omnidirectional characteristics in order to calculate microphone directional signals. However, in this case, the direction once set cannot actively respond according to situations. Additionally, when changing, correcting, and setting the direction, cumbersome procedures must be followed.

Korean Patent No. 10-2004460 relates to a digital hearing device using Bluetooth circuit and digital signal processing, and discloses a technology for a digital hearing device that may provide optimized hearing functions suitable for user's hearing profile and hearing aid wearing environment in limited resources of Bluetooth module by using Bluetooth circuit and digital signal processing.

### PRIOR ART DOCUMENTS

### Patent Documents

Korean Patent No. 10-2004460

### SUMMARY

The embodiments describe a stereo type digital hearing device connected with an external device with built-in microphone and an operation method thereof, and more particularly, provide a technology for a stereo type digital hearing device that allows feeling sense of direction and space similar to sound heard in ears by receiving external sound through a microphone built in an external device.

The embodiments provide a stereo type digital hearing device connected with an external device with built-in microphone that may transmit sound, even sound that cannot be heard at a close distance due to hearing loss, without excessive amplification by receiving external sound through a microphone built in an external device and providing stereo sound having sense of direction and space and an operation method thereof.

An operation method of a stereo type digital hearing device connected with an external device with built-in microphone according to an embodiment may include connecting a digital hearing device worn by a user and an external device carried by the user or located around the user to each other through wireless communication; receiving external sound through a microphone built in the external device; transmitting the sound received from the external device to the digital hearing device; and amplifying the sound transmitted from the digital hearing device and delivering it to the user through a speaker.

The connecting to each other through wireless communication may include configuring the digital hearing device with two of a first digital hearing device and a second digital hearing device so that it may be worn on both ears of the user and connecting the first digital hearing device and a first external device to each other through wireless communication; and connecting the second digital hearing device and a second external device to each other through wireless communication.

The connecting to each other through wireless communication may be configured that the first digital hearing device recognizes and connects to the first external device located closer than the second external device, and the second digital hearing device connects to the second external device.

The transmitting the sound to the digital hearing device may include transmitting the sound received from the first external device to the first digital hearing device; and transmitting the sound received from the second external device to the second digital hearing device.

The amplifying the sound and delivering it to the user through the speaker may provide stereo sound with sense of direction and space by amplifying the sound transmitted from the external device and the external sound received through the microphone configured in the digital hearing device together

It may further include estimating a location where the sound occurs by comparing the sound transmitted from the external device and the sound received through the microphone configured in the digital hearing device for the same external sound; and automatically changing a beamforming value for microphone directivity according to the estimated location where the sound occurs.

The automatically changing the beamforming value may apply the beamforming value for microphone directivity suitable for each environment to the microphone built in the external device, but automatically change the beamforming value through a predetermined algorithm.

The external device may be at least one of a cradle, a remote controller, and a user terminal in which the digital hearing device is built.

A stereo type digital hearing device connected with an external device with built-in microphone according to another embodiment may include a digital hearing device for amplifying transmitted sound and delivering it to a user through a speaker; and an external device carried by the user or located around the user, connected with the digital hearing device to each other through wireless communication, and receiving external sound through a built-in microphone and transmitting it to the digital hearing device.

The digital hearing device may be configured with two of a first digital hearing device and a second digital hearing device so that it may be worn on both ears of the user, and the first digital hearing device and a first external device may be connected to each other through wireless communication, and the second digital hearing device and a second external device may be connected to each other through wireless communication.

The sound received from the first external device may be transmitted to the first digital hearing device, and the sound received from the second external device may be transmitted to the second digital hearing device.

The digital hearing device may include a body; an ear band configured to extend from one side of the body and surround at least a part of the user's auricle; a microphone placed on the ear band; an ear head configured to have a protruding shape on the inside of the body and fitted to the user's ear; a speaker configured in the ear head and amplifying the sound received from the microphone and transmitting it to the user; a wireless communication unit configured in the body, and connected with the external device through wireless communication; and a control unit configured in the body, and connected to the external device through the wireless communication unit to transmit and receive sound data and control signals.

The control unit may provide stereo sound with sense of direction and space by amplifying the sound transmitted from the external device and the external sound received through the microphone configured in the digital hearing device together.

The digital hearing device may include a sound location estimating unit for estimating a location where the sound occurs by comparing the sound transmitted from the external device and the sound received through the microphone configured in the digital hearing device for the same external sound; and a beamforming setting unit for automatically changing a beamforming value for microphone directivity according to the estimated location where the sound occurs.

The beamforming setting unit may apply the beamforming value for microphone directivity suitable for each environment to the microphone built in the external device, but automatically change the beamforming value through a predetermined algorithm.

The external device may be at least one of a cradle, a remote controller, and a user terminal in which the digital hearing device is built.

According to embodiments, it may provide a stereo type digital hearing device connected with an external device with built-in microphone that may transmit sound, even sound that cannot be heard at a close distance due to hearing loss, without excessive amplification by receiving external sound through a microphone built in an external device and providing stereo sound having sense of direction and space and an operation method thereof.

### BRIEF DESCRIPTION OF THE DRAWINGS

These and/or other aspects, features, and advantages of the disclosure will become apparent and more readily appreciated from the following description of embodiments, taken in conjunction with the accompanying drawings of which:

FIG. 1 is a drawing for describing a stereo type digital hearing device connected with an external device with built-in microphone according to an embodiment;

FIG. 2 is a drawing representing a stereo type digital hearing device according to an embodiment;

FIG. 3 is a drawing representing a cradle in which a microphone is configured according to an embodiment;

FIG. 4 is a drawing representing a cradle in which a microphone is configured and a stereo type digital hearing device built in the cradle according to an embodiment;

FIG. 5 is a drawing for describing sense of direction and space using a stereo type digital hearing device connected with an external device with two built-in microphones according to an embodiment;

FIG. 6 is a drawing for describing a microphone directivity value suitable for environment according to an embodiment;

FIG. 7 is a drawing for describing a microphone directivity value suitable for environment automatically changed by using an algorithm according to an embodiment; and

FIG. 8 is a drawing for describing transmission of sound to a digital hearing device through a microphone built in an external device according to an embodiment.

FIG. 9 is a flow chart illustrating an operation method of a stereo type digital hearing device connected with an external device with built-in microphone according to an embodiment.

FIG. 10 is a block diagram illustrating a stereo type digital hearing device connected with an external device with built-in microphone according to an embodiment.

### DETAILED DESCRIPTION

Hereinafter, embodiments are described with reference to the accompanying drawings. However, the described embodiments may be modified in various other forms, and the scope of the present disclosure is not restricted by the following embodiments. Furthermore, various embodiments are provided to more fully describe the present disclosure to a person having average knowledge in the art. The shapes, sizes, etc. of elements in the drawings may be exaggerated for a clear description.

The following embodiments relate to a stereo type digital hearing device connected with an external device with built-in microphone, and in addition to sound transmitted to a digital hearing device (e.g., hearing aids), more comprehensive sound may be transmitted through a microphone equipped in other external devices. Accordingly, embodiments may provide a stereo type digital hearing device that allows feeling sense of direction and space similar to sound heard in ears through a microphone of an external device.

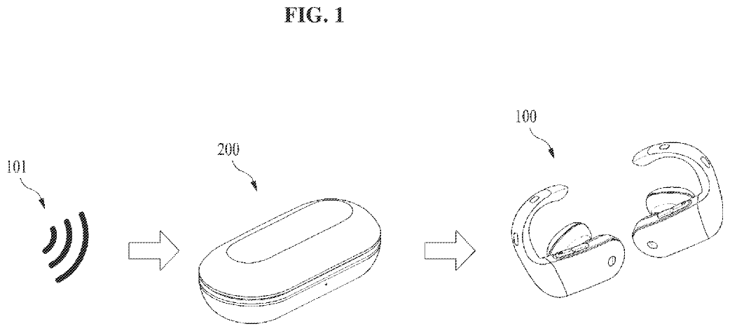

FIG. 1 is a drawing for describing a stereo type digital hearing device connected with an external device with built-in microphone according to an embodiment.

Referring to FIG. 1, embodiments may transmit external sound to a microphone configured in an external device, and then convert it to sound suitable for a user environment through an algorithm in the microphone configured in the external device and transmit it to a digital hearing device. Here, the external device may be a cradle, a remote controller, a user terminal, etc., and the microphone is included in the external device and it may transmit external sound to a stereo type digital hearing device.

While recent hearing aids provide mono type sound, embodiments may provide stereotype sound that allows feeling sense of direction and space through the microphone configured in the external device. Also, embodiments may correct and assist insufficient hearing status in order to clearly hear at a long distance by fitting to naturally feel gap between loud sound and soft sound through a hearing aid algorithm mounted on a Digital Signal Processor (DSP).

Also, embodiments may solve a problem of hearing loss that may result from excessive sound amplification in order to hear sound from near or long distance, and perform an auxiliary role in transmitting sound from a long distance through a microphone built in the external device.

In the below, a stereo type digital hearing device connected with an external device with built-in microphone and a cradle according to an embodiment will be described with an example. Here, as one example, a digital hearing device configured with at least one or more microphone in an ear band will be described as an example, but the stereo type digital hearing device connected with an external device with built-in microphone and the cradle according to the embodiment are not limited thereto.

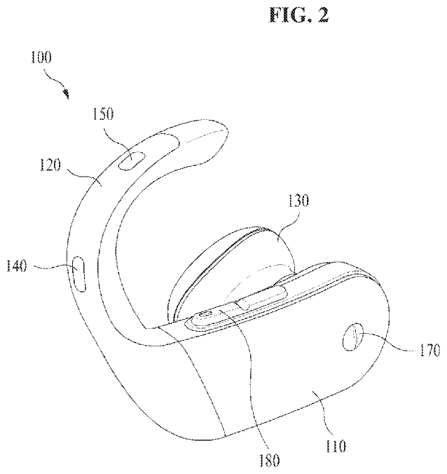

FIG. 2 is a drawing representing a stereo type digital hearing device according to an embodiment.

Referring to FIG. 2, a stereo type digital hearing device connected with an external device with built-in microphone 100 according to an embodiment may be configured to include a body 110, an ear band 120, an ear head 130, at least one or more microphones 140, 150, and a speaker. In addition, the stereo type digital hearing device connected with an external device with built-in microphone 100 according to an embodiment may further include at least one or more of a microphone for calls 160, a wireless communication unit, a control unit, a power supply unit, a sound location estimating unit, and a beamforming setting unit.

The body 110 may be attached to or worn on a user's ear, and include a wireless communication unit, a control unit, a power supply unit, and the like inside. Such body 110 may be close to the ear without being inserted into the ear.

The ear band 120 may be configured to be extended from one side of the body 110 and surround at least a part of the user's auricle, and at least one or more microphones 140, 150 may be configured in the ear band 120.

For example, the body 110 and the ear band 120 may be formed in a ‘C’ shape, and fitted and fixed in a diagonal direction from the front upper side to the back lower side of the user's ear. The body 110 and the ear band 120 may be formed by injecting synthetic resin or formed of stainless steel (STS), aluminum (Al), or titanium (Ti), etc. However, it is not limited thereto, and by using various materials, the body 110 and the ear band 120 may be formed.

The ear head 130 may be configured to have a protruding shape on the inside of the body 110 and fitted to the user's ear.

Here, the ear head 130 may be configured in an open type without protrusions closed to the ear or in a nozzle type with protrusions. Also, the ear head 130 may be configured to be selectively used by combining an open type or nozzle type silicon cover. In this case, the ear head 130 is configured in an open type, and when combining the silicon cover to the lower part of the ear head 130, it may be determined as an open type or a nozzle type depending on the shape of the silicon cover. For example, when combining the silicon cover including protrusions to the open type ear head 130, it may be used as the nozzle type.

At this time, the ear head 130 may minimize occlusion by configuring at least one or more leakage holes in a protruding part of a nozzle type nozzle unit. Here, the occlusion is that when speaking, as vibration of vocal cords vibrates skull including jawbone, this vibration is transmitted to cartilage zone of external auditory canal, and when wearing hearing aids, vibration is directed toward eardrum, and new sound is created in the space between the eardrum and the hearing aids, so the vibration is occurs. According to an embodiment, the occlusion may be minimized by configuring the leakage hole in the protruding part of the ear head 130.

The at least one or more microphones 140, 150 are for transmitting external sound to a user, and at least one or more may be configured in the ear band 120. At this time, if the at least one or more microphones 140, 150 are configured as two or more, they may be placed in the ear band 120 at predetermined intervals. Like this, as the microphone is placed in the ear band 120, due to the distance from the speaker, there are fewer restrictions on howling, making amplification easier. Such microphone is configured to receive the user's voice and other external sound, and may process external sound signals into electrical voice data.

For example, if the at least one or more microphones 140, 150 are configured as two or more, the at least one or more microphones 140, 150 may be placed in the ear band 120 to face different directions when the user wears it on the ear. More particularly, the at least one or more microphones 140, 150 may be configured to include a first microphone 140 placed to face the front based on the user's face and recognizing sound from the front when worn and a second microphone 150 placed to face the back or top of the user's head and recognizing sound from the back when worn. Meanwhile, the at least one or more microphones 140, 150 are not limited to one and may configured with three or more.

Meanwhile, the stereo type digital hearing device connected with an external device with built-in microphone 100 according to an embodiment may further include a separate microphone for calls 160. The microphone for calls 160 is configured in the body 110, and may recognize the user's voice signals when connecting a call using a user terminal.

For example, the microphone for calls 160 may be configured on the lower side of the body 110, and recognize the user's voice toward the user's mouth. Particularly, the microphone for calls 160 may be placed at the location closest to the user's mouth.

The speaker may be configured in the ear head 130 and amplify sound received from a plurality of microphones and transmit it to the user. Also, the speaker may transmit sound data received through the user terminal to the user.

Meanwhile, the stereo type digital hearing device connected with an external device with built-in microphone 100 according to an embodiment may serve as not only a function as hearing aids but also a function as wireless earphones by linking with a user terminal.

The user terminal described in this specification may include a mobile phone, a smart phone, a laptop computer, a terminal for digital broadcasting, a Personal Digital Assistants (PDA), a Portable Multimedia Player (PMP), a slate PC, a tablet PC, an ultrabook, a wearable device (e.g., a smartwatch, a smart glass, a Head Mounted Display (HMD), etc.), and the like.

The wireless communication unit is configured to be built in the body 110, and is connected with the user terminal through wireless communication. In other words, the wireless communication unit may be configured to receive and transmit wireless signals from the user terminal in communication network according to wireless Internet technologies.

The wireless Internet technologies are, for example, WLAN (Wireless LAN), Wi-Fi (Wireless-Fidelity), Wi-Fi (Wireless Fidelity) Direct, DLNA (Digital Living Network Alliance), WiBro (Wireless Broadband), WiMAX (World Interoperability for Microwave Access), HSDPA (High Speed Downlink Packet Access), HSUPA (High Speed Uplink Packet Access), LTE (Long Term Evolution), LTE-A (Long Term Evolution-Advanced), etc., and the wireless communication unit may receive and transmit data according to at least one wireless Internet technology in a range including Internet technologies not listed above.

Meanwhile, the wireless communication unit may perform short range communication. As the short range communication, at least one of Bluetooth, RFID (Radio Frequency Identification), Infrared Data Association (IrDA), UWB (Ultra Wideband), ZigBee, NFC (Near Field Communication), Wi-Fi (Wireless-Fidelity), Wi-Fi Direct, Wireless USB (Wireless Universal Serial Bus) technologies may be used. However, it is not limited thereto, and the wireless communication unit may receive data from a mobile terminal through short range communication technologies not listed above.

Like this, the wireless communication unit may receive sound data from a mobile terminal through the short range communication. However, it is not limited thereto, and the wireless communication unit may receive sound data from the user terminal through wireless Internet technologies.

The control unit is configured in the body 110, and may be implemented to control overall operations of components. The control unit may amplify sound received from a plurality of microphones and transmit it to the user. Also, the control unit may receive and transmit sound data and control signals by being connected with the user terminal through the wireless communication unit.

Particularly, the control unit may control to operate with at least one mode of a hearing aid mode, a calling mode, and an earphone mode. As one example, when setting as the hearing aid mode, the at least one or more microphones 140, 150 may be ON status, and when setting as the calling mode or the earphone mode, the at least one or more microphones 140, 150 may be OFF status. In this case, by using the separately configured microphone for calls 160, a calling function may be used.

As another example, when the control unit sets as the hearing aid mode, the at least one or more microphones 140, 150 may be ON status, and when it sets as the calling mode, one microphone placed on the part closest to the user's mouth among the at least one or more microphones 140, 150 may be ON status, and the other microphone may be OFF status. For example, the first microphone 140 placed to face the front based on the user's face and recognizing sound from the front may be ON status, the second microphone 150 placed to face the back or top of the user's head and recognizing sound from the back may be OFF status, and the calling function may be used by using the first microphone 140.

Like this, the control unit may ON/OFF the power of at least one microphone among the at least one or more microphones 140, 150, and furthermore, may control amplification gain of each of the at least one or more microphones 140, 150.

At this time, the control unit may set amplification gain of each of the at least one or more microphones 140, 150 according to control signals transmitted through an application of the user's terminal. In other words, the user may install an application in the user's terminal, and then set amplification gain of each of the at least one or more microphones 140, 150 by running the application, and the control unit may set amplification gain for each microphone by receiving such control signals.

The power supply unit supplies power necessary for an operation of each component by receiving external and internal power by control of the control unit. The power supply unit includes a battery, and the battery may be a built-in battery that may be recharged. However, it is not limited thereto.

Also, a power button unit 170 and/or a volume button unit 180 may be further included. At this time, one button of the power button unit 170 and the volume button unit 180 may be configured, and it is possible to turn on or off the power or control volume through the one button. For example, the power button unit 170 is configured in a touch or button pressing way, and when touching or pressing the button for more than a predetermined time, the power is turned on or off, and when touching or pressing the button quickly one time, sound becomes louder, and when touching or pressing the button two times, sound may become quieter. At this time, the method for turning on or off the power and controlling volume may be set by the user. As another example, the volume button unit 180 is configured in a button pressing way, and two buttons are configured so that the volume of sound may be increased or decreased by pressing each button. At this time, it may set the power to turn on or off by pressing at least one button of two buttons for more than a predetermined time. As another example, the volume button unit 180 may be connected to the microphone for calls 160 on the lower side with one frame. More particularly, one frame which is curvilinear along the outer periphery of the body 110 is configured, the volume button unit 180 is configured on one side of the frame placed on the upper side, and the microphone for calls 160 may be configured on the other side of the frame placed on the lower side. At this time, a button unit may be configured on the microphone for calls 160 so that calls may be connected by pressing the button. According to the setting, the entire power may be turned on or off by pressing the button unit for more than a predetermined time.

As described above, according to embodiments, more efficient sound amplification is possible by placing the microphone toward the ear band 120. Also, according to embodiments, the at least one or more microphones 140, 150 are placed on the ear band 120 at a predetermine distance from each other, thereby minimizing the howling effect when placing behind the auricle.

The embodiments are configured in a structure of a sports earphone form rather than the existing general hearing aid form and implemented so that earphone and hearing aid functions may be used simultaneously. Also, according to embodiments, earbud fit and inner molding are excellent, so waterproof (IPX7) is possible on hearing aids/earphones characteristics.

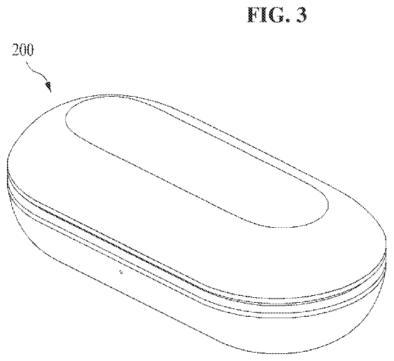

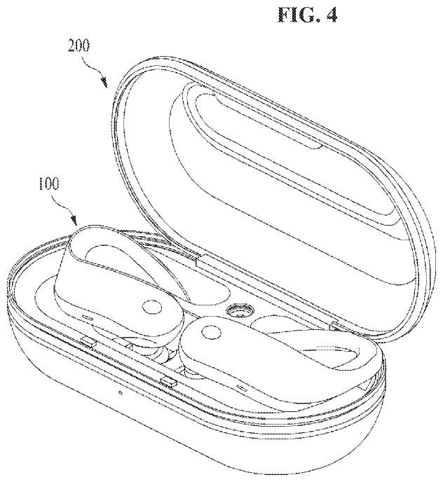

FIG. 3 is a drawing representing a cradle in which a microphone is configured according to an embodiment, and FIG. 4 is a drawing representing a cradle in which a microphone is configured and a stereo type digital hearing device built in the cradle according to an embodiment.

Referring to FIGS. 3 and 4, the stereo type digital hearing device connected with an external device with built-in microphone 100 according to an embodiment may further include a cradle 200 for storage and charge, and for example, two of the stereo type digital hearing devices 100 may be pair and accommodated in the cradle 200. Such cradle 200 may charge the stereo type digital hearing device 100 by including a battery, and the battery of the cradle 200 may be charged through a cable.

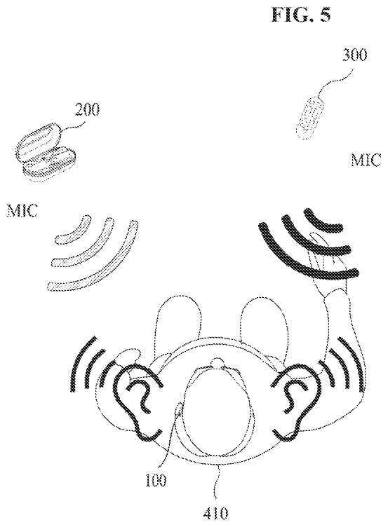

FIG. 5 is a drawing for describing sense of direction and space using a stereo type digital hearing device connected with an external device with two built-in microphones according to an embodiment.

Referring to FIG. 5, as a user 410 wears the stereo type digital hearing device 100, external sound may be received through a microphone of external devices 200, 300 carried by the user 410 or located around the user 410. At this time, external sound may be received through a microphone of the stereo type digital hearing device 100 worn by the user 410. Like this, the user 410 may feel more accurate sense of direction and space by receiving external sound from at least two or more locations.

For example, after receiving external sound by using the cradle 200 in which the digital hearing device 100 is built and a remote controller 300 for controlling functions of the digital hearing device 100, the external sound received from the cradle 200 and the remote controller 300 may be transmitted to the digital hearing device 100. At this time, there are two channels constituting sound, and different sound are emitted from both digital hearing devices 100 through the microphone of both external devices 200, 300, so that the sense of direction and space may be felt.

As one example, external sound input to the cradle 200 is transmitted to the left digital hearing device 100 worn by the user 410, and external sound input to the remote controller 300 may be transmitted to the right digital hearing device 100 worn by the user 410. As another example, external sound input to the cradle 200 may be transmitted to the right digital hearing device 100 worn by the user 410, and external sound input to the remote controller 300 may be transmitted to the left digital hearing device 100 worn by the user 410. Also, the external device 200, 300 closer to the left digital hearing device 100 among the cradle 200 and the remote controller 300 may transmit external sound to the left digital hearing device 100, and the other one external device 200, 300 300 may transmit external sound to the right digital hearing device 100. On the contrary, the external device 200, 300 closer to the right digital hearing device 100 among the cradle 200 and the remote controller 300 may transmit external sound to the right digital hearing device 100, and the other one external device 200, 300 may transmit external sound to the left digital hearing device 100. Also, additional microphone is configured in the left and right digital hearing devices 100 so that external sound may be transmitted to the user 410.

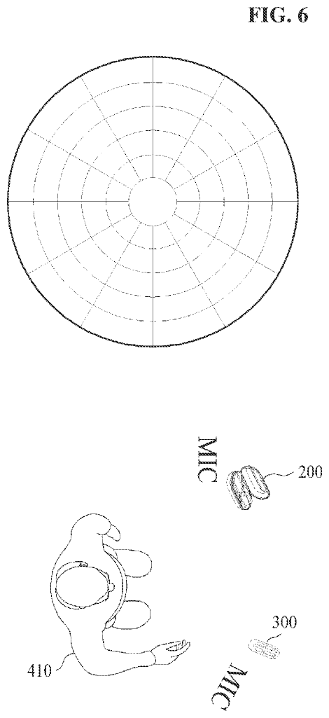

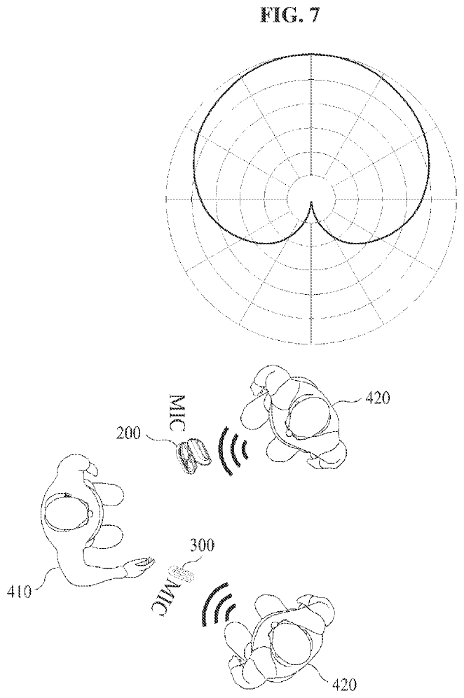

FIG. 6 is a drawing for describing a microphone directivity value suitable for environment according to an embodiment, and FIG. 7 is a drawing for describing a microphone directivity value suitable for environment automatically changed by using an algorithm according to an embodiment.

Referring to FIGS. 6 and 7, in embodiments, a microphone directivity value suitable for each environment may be automatically changed through a microphone of external devices 200, 300. For example, a location where sound occurs may be estimated by comparing sound transmitted from the external devices 200, 300 and sound received from the microphone configured in a digital hearing device for the same external sound. Then, according to the estimated location where the sound occurs, a beamforming value for microphone directivity may be automatically changed. At this time, the beamforming value for microphone directivity suitable for each environment may be applied to the microphone built in the external devices 200, 300, but the beamforming value may be automatically changed through a predetermined algorithm. Here, the external sound may be sound that an object 420 speaks to a user 410. The user 410 may estimate a location where the sound occurs, i.e., a location of the object 420 speaking among at least one or more objects 420, and accordingly, it may automatically change the microphone directivity through an algorithm.

Like this, embodiments may automatically change a beamforming value suitable for each situation and environment through the microphone of the digital hearing device and the external devices 200, 300 from the center of the user 410. Accordingly, even sound that cannot be heard at a close distance due to hearing loss may be transmitted without excessive amplification.

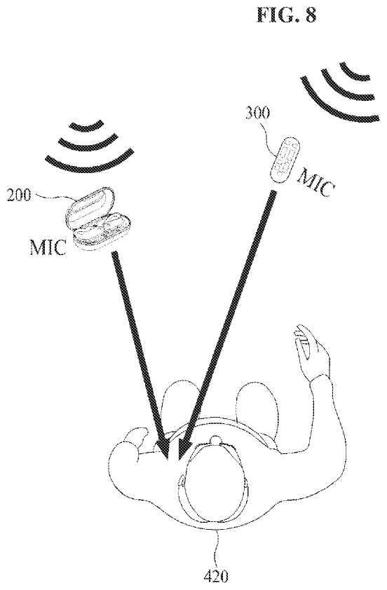

FIG. 8 is a drawing for describing transmission of sound to a digital hearing device through a microphone built in an external device according to an embodiment.

Referring to FIG. 8, a microphone is installed in an external device connected with a digital hearing device through wireless communication, so that external sound received from the external device may be transmitted to the digital hearing device. Here, the external device means a cradle, a remote controller, a user terminal, and the like in which the digital hearing device is built, and this may include all of operation, charging, additional design elements, and the like of earphones.

Accordingly, without excessive amplification of the digital hearing device, sound at a long distance may be transmitted to the digital hearing device through the microphone built in the external device.

At this time, the external device may be configured with one or more, e.g., two. Also, at least one or more microphones may be configured in the digital hearing device, and for example, one microphone may be configured in each of a pair of digital hearing devices. Like this, as the microphones are configured in at least two or more locations rather than one location, stereo type of sound may be provided.

In addition, by comparing sound reaching to the external device and sound reaching to the hearing aids, a location of the other side, i.e., a location where sound occurs may be estimated. At this time, the location where the sound occurs may be estimated by using artificial intelligence or according to the estimated location where the sound occurs, the beamforming value for the microphone directivity of the microphone of the external device and/or the microphone of the digital hearing device may be automatically changed.

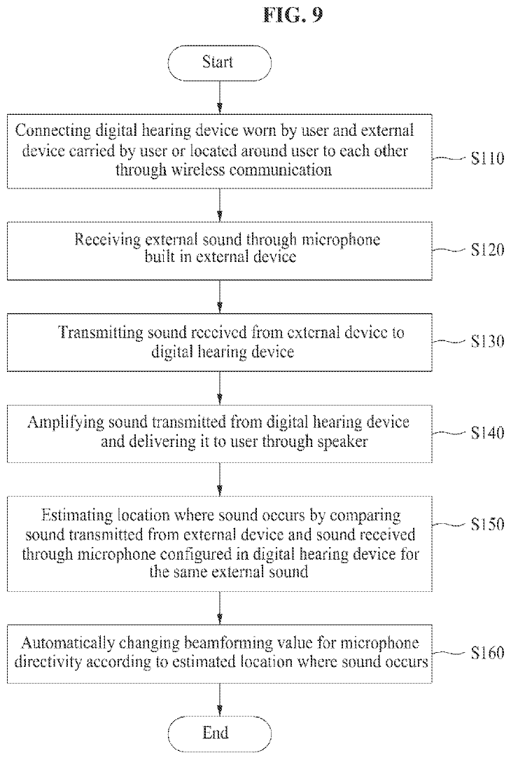

FIG. 9 is a flow chart illustrating an operation method of a stereo type digital hearing device connected with an external device with built-in microphone according to an embodiment.

Referring to FIG. 9, an operation method of a stereo type digital hearing device connected with an external device with built-in microphone according to an embodiment may include connecting a digital hearing device worn by a user and an external device carried by the user or located around the user to each other through wireless communication S110, receiving external sound through a microphone built in the external device S120, transmitting the sound received from the external device to the digital hearing device S130, and amplifying the sound transmitted from the digital hearing device and delivering it to the user through a speaker S140.

Also, it may further include estimating a location where the sound occurs by comparing the sound transmitted from the external device and the sound received through the microphone configured in the digital hearing device for the same external sound S150, and automatically changing a beamforming value for microphone directivity according to the estimated location where the sound occurs S160.

In the below, the operation method of the stereo type digital hearing device connected with an external device with built-in microphone according to an embodiment will be described in more detail.

The operation method of the stereo type digital hearing device connected with an external device with built-in microphone according to an embodiment may be described in more detail with an example of a stereo type digital hearing device connected with an external device with built-in microphone according to an embodiment.

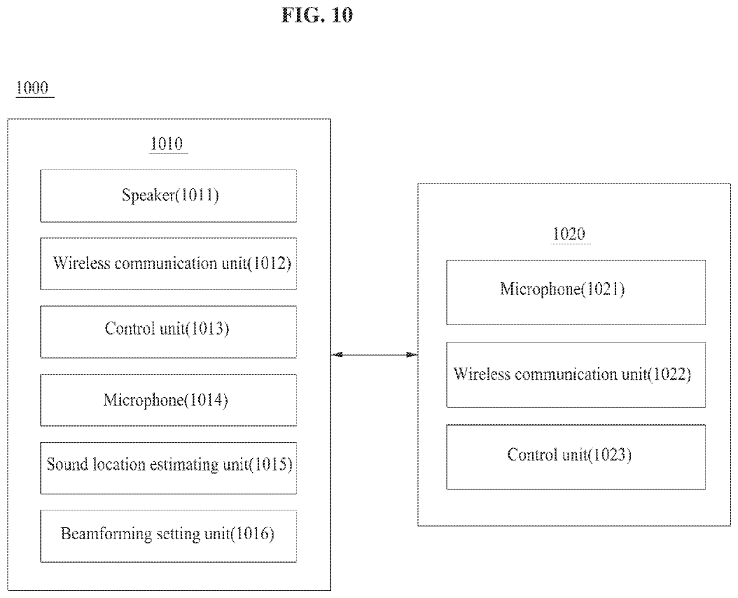

FIG. 10 is a block diagram illustrating a stereo type digital hearing device connected with an external device with built-in microphone according to an embodiment.

Referring to FIG. 10, a stereo type digital hearing device connected with an external device with built-in microphone 1000 according to an embodiment may be configured to include a digital hearing device 1010 and an external device 1020. Here, the digital hearing device 1010 may amplify transmitted sound and deliver it to a user through a speaker 1011, and include a body, an ear band, an ear head, a speaker 1011, a wireless communication unit 1012, and a control unit 1013, and may further include a microphone 1014, a sound location estimating unit 1015, and a beamforming setting unit 1016. The external device 1020 may be carried by the user or located around the user, connected with the digital hearing device 1010 to each other through wireless communication, and receive external sound through a built-in microphone 1021 and transmit it to the digital hearing device 1010, and may include the microphone 1021, a wireless communication unit 1022, and a control unit 1023. At this time, the external device 1020 may be any one or more of a cradle, a remote controller, and a user terminal in which the digital hearing device 1010 is built. Also, the external device 1020 is not limited thereto, and it may include an accessory with additional built-in microphone and the like.

In step S110, the digital hearing device worn by the user and the external device carried by the user or located around the user may be connected to each other through wireless communication.

For example, the digital hearing device may be configured with two of a first digital hearing device and a second digital hearing device so that they can be worn on both ears of the user, the first digital hearing device may be connected with a first external device to each other through wireless communication, and the second digital hearing device may be connected with a second external device to each other through wireless communication. At this time, the first digital hearing device may recognize and connect to the first external device located closer than the second external device, and the second digital hearing device may connect to the second external device.

In step S120, external sound may be received through the microphone built in the external device.

In step S130, the sound received from the external device may be transmitted to the digital hearing device.

For example, the sound received from the first external device may be transmitted to the first digital hearing device, and the sound received from the second external device may be transmitted to the second digital hearing device.

In step S140, the sound transmitted from the digital hearing device may be amplified and delivered to the user through the speaker.

By amplifying the sound transmitted from the external device and the sound received through the microphone configured in the digital hearing device together, stereo sound with sense of direction and space may be provided.

In step S150, the sound location estimating unit may estimate the location where the sound occurs by comparing the sound transmitted from the external device and the sound received through the microphone configured in the digital hearing device for the same external sound.

In step S160, the beamforming setting unit may automatically change the beamforming value for the microphone directivity according to the estimated location where the sound occurs. The beamforming setting unit may apply the beamforming value for the microphone directivity suitable for each environment to the microphone built in the external device, but may automatically change the beamforming value through the predetermined algorithm.

Accordingly, by estimating the direction or location of the object talking to the user or estimating the direction or location where the sound occurs, the beamforming for the microphone directivity may be automatically changed according to the direction or location where the object or the sound occurs.

As described above, embodiments are hearing assistance devices for people with hearing loss who are difficult to hear sound in some frequency bands of audible frequency bands, and complement for the hearing loss by amplifying or compressing the sound according to hearing status of each individual with hearing loss. Embodiments may provide optimal stereo type sound suitable for each environment through an additional microphone built in the external device in a mono type that produces the same sound from the existing both hearing aid speakers.

When it is mentioned that one component is “connected” or “accessed” to another component, it may be understood that the one component is directly connected or accessed to another component or that still other component is interposed between the two components. In contrast, when it is mentioned that one component is “directly connected” or “directly accessed” to another component, it may be understood that there is no intervening component therebetween.

The terms used herein are for describing various example embodiments only, and are not construed to limit the disclosure. The singular forms “a,” “an,” and “the” are intended to include the plural forms as well, unless the context clearly indicates otherwise. It will be further understood that the terms “comprises/comprising” and/or “includes/including” when used herein, specify the presence of stated features, integers, steps, operations, elements, and/or components, but do not preclude the presence or addition of one or more other features, integers, steps, operations, elements, components and/or groups thereof.

Although the terms “first,” “second,” and the like are used to explain various components, the components are not limited to such terms. These terms are used only to distinguish one component from another component.

Also, the terms “ . . . portion,” “ . . . module,” used herein refer to a unit for processing at least one function or operation, which may be implemented through hardware or software, or combination of hardware and software.

Also, a component of an example embodiment described with reference to each drawing may be implemented to be included in other example embodiments within the scope in which the technical spirit of the disclosure is maintained, without being limitedly applied to the corresponding example embodiment only. Also, although a separate description is omitted, a plurality of example embodiments may be implemented as a single integrated example embodiment.

Also, when describing with reference to the accompanying drawings, like reference numerals refer to like elements throughout and repeated description related thereto is omitted. When it is determined that detailed description of a related known art may unnecessarily obscure the gist of the disclosure, the detailed description is omitted.

While this disclosure includes specific example embodiments, it will be apparent to one of ordinary skill in the art that various alterations and modifications in form and details may be made in these example embodiments without departing from the spirit and scope of the claims and their equivalents. For example, suitable results may be achieved if the described techniques are performed in a different order, and/or if components in a described system, architecture, device, or circuit are combined in a different manner, and/or replaced or supplemented by other components or their equivalents.

Therefore, other implementations, other example embodiments, and equivalents are within the scope of the following claims.

1. An operation method of a stereo type digital hearing device connected with an external device with built-in microphone, comprising:
connecting a digital hearing device worn by a user and an external device carried by the user or located around the user to each other through wireless communication;
receiving external sound through a microphone built in the external device;
transmitting the sound received from the external device to the digital hearing device; and
amplifying the sound transmitted from the digital hearing device and delivering it to the user through a speaker.

2. The operation method of a stereo type digital hearing device of claim 1, wherein the connecting to each other through wireless communication comprises:
configuring the digital hearing device with two of a first digital hearing device and a second digital hearing device so that it may be worn on both ears of the user and connecting the first digital hearing device and a first external device to each other through wireless communication; and
connecting the second digital hearing device and a second external device to each other through wireless communication.

3. The operation method of a stereo type digital hearing device of claim 2, wherein the connecting to each other through wireless communication is configured that the first digital hearing device recognizes and connects to the first external device located closer than the second external device, and the second digital hearing device connects to the second external device.

4. The operation method of a stereo type digital hearing device of claim 2, wherein the transmitting the sound to the digital hearing device comprises:
transmitting the sound received from the first external device to the first digital hearing device; and
transmitting the sound received from the second external device to the second digital hearing device.

5. The operation method of a stereo type digital hearing device of claim 1, wherein the amplifying the sound and delivering it to the user through the speaker provides stereo sound with sense of direction and space by amplifying the sound transmitted from the external device and the external sound received through the microphone configured in the digital hearing device together.

6. The operation method of a stereo type digital hearing device of claim 1, further comprising:
estimating a location where the sound occurs by comparing the sound transmitted from the external device and the sound received through the microphone configured in the digital hearing device for the same external sound; and
automatically changing a beamforming value for microphone directivity according to the estimated location where the sound occurs.

7. The operation method of a stereo type digital hearing device of claim 1, wherein the automatically changing the beamforming value applies the beamforming value for microphone directivity suitable for each environment to the microphone built in the external device, but automatically changes the beamforming value through a predetermined algorithm.

8. The operation method of a stereo type digital hearing device of claim 1, wherein the external device is at least one of a cradle, a remote controller, and a user terminal in which the digital hearing device is built.

9. A stereo type digital hearing device connected with an external device with built-in microphone, comprising:
a digital hearing device for amplifying transmitted sound and delivering it to a user through a speaker; and
an external device carried by the user or located around the user, connected with the digital hearing device to each other through wireless communication, and receiving external sound through a built-in microphone and transmitting it to the digital hearing device.

10. The stereo type digital hearing device of claim 9, wherein the digital hearing device is configured with two of a first digital hearing device and a second digital hearing device so that it may be worn on both ears of the user, and wherein the first digital hearing device and a first external device are connected to each other through wireless communication, and the second digital hearing device and a second external device are connected to each other through wireless communication.

11. The stereo type digital hearing device of claim 10, wherein the sound received from the first external device is transmitted to the first digital hearing device, and the sound received from the second external device is transmitted to the second digital hearing device.

12. The stereo type digital hearing device of claim 9, wherein the digital hearing device comprises:
a body;
an ear band configured to extend from one side of the body and surround at least a part of the user's auricle;
a microphone placed on the ear band;
an ear head configured to have a protruding shape on the inside of the body and fitted to the user's ear;
a speaker configured in the ear head and amplifying the sound received from the microphone and transmitting it to the user;
a wireless communication unit configured in the body, and connected with the external device through wireless communication; and
a control unit configured in the body, and connected to the external device through the wireless communication unit to transmit and receive sound data and control signals.

13. The stereo type digital hearing device of claim 12, wherein the control unit provides stereo sound with sense of direction and space by amplifying the sound transmitted from the external device and the external sound received through the microphone configured in the digital hearing device together.

14. The stereo type digital hearing device of claim 9, wherein the digital hearing device comprises:
a sound location estimating unit for estimating a location where the sound occurs by comparing the sound transmitted from the external device and the sound received through the microphone configured in the digital hearing device for the same external sound; and
a beamforming setting unit for automatically changing a beamforming value for microphone directivity according to the estimated location where the sound occurs.

15. The stereo type digital hearing device of claim 9, wherein the beamforming setting unit applies the beamforming value for microphone directivity suitable for each environment to the microphone built in the external device, but automatically changes the beamforming value through a predetermined algorithm.

16. The stereo type digital hearing device of claim 9, wherein the external device is at least one of a cradle, a remote controller, and a user terminal in which the digital hearing device is built.
